(19) United States
(12) Patent Application Publication
(10) Pub. No.: US 2026/0037846 A1
(43) Pub. Date: Feb. 5, 2026

(54) METHODS FOR USING QUANTUM COMPUTERS BY USING STATES ROTATED IN A TWO-DIMENSIONAL INVARIANT SUBSPACE

(71) Applicant: Quantinuum Ltd., London (GB)

(72) Inventors: Steven Herbert, London (GB); Ifan Williams, London (GB)

(73) Assignee: Quantinuum Ltd., London (GB)

(21) Appl. No.: 18/998,651

(22) PCT Filed: Jul. 31, 2023
(86) PCT No.: PCT/GB2023/052025

§ 371 Date: Jan. 27, 2025

(30) Foreign Application Priority Data
Jul. 31, 2022 (GB) 2211165.2
Feb. 1, 2023 (GB) 2301482.2

(51) Int. Cl. G06N 10/20; G06N 10/60

(52) U.S. Cl. CPC G06N 10/20; G06N 10/60

(57) ABSTRACT

There is provided a method for modifying any quantum phase-estimation-free quantum amplitude-estimation algorithm, to improve the statistical performance and robustness of the amplitude estimation. A phase-estimation-free amplitude-estimation algorithm provides an estimate for the amplitude of a desired quantum state, realised by performing classical post-processing for combined measurement data resulting from a number of different quantum circuits derived from the desired quantum state. The method for modifying any such algorithm prepares quantum circuits that each correspond to different initial states (chosen either quasi-randomly, randomly, or deterministically). These are prepared using linear combinations of unitary operations, and each initial state corresponds to a state rotated in the two-dimensional invariant subspace to a corresponding initial angle. This introduces variability to any phase-estimation-free amplitude-estimation algorithm, and will lead to improved statistical performance and robustness when considering the estimator for the amplitude. This is explicitly demonstrated by considering an example, where a phase-estimation-free amplitude-estimation algorithm is supplemented using the method, and the detailed properties of its estimator then analysed. This method is especially motivated for quantum Monte-Carlo integration (QMCI) computations, but is expected to find application in many other areas of practical use.

### TECHNICAL FIELD

The present disclosure relates to methods for using quantum computers, for example methods of using quantum computers by using states rotated in a two-dimensional subspace. Moreover, the present disclosure also related to software products for execution on quantum computing hardware for implementing the aforesaid methods.

### BACKGROUND

Quantum computers are inherently suitable for determining properties of complex physical systems and computational systems, because they exploit quantum phenomena. Unlike classical digital computers in which the basic unit of computation, the bit, is in one of two discrete binary states (1 or 0), quantum computers utilise qubits or qudits which may exist in a superposition of many different computational states. This allows a quantum computer to investigate many different states in parallel. However, quantum computers are vulnerable to noise which may lead to decoherence between the different quantum states. This noise problem becomes more significant as the number of qubits increases for more complex computational processing.

Monte Carlo methods use random sampling to estimate numerical properties of systems which are too large or too complex to analyze deterministically. It is known that quantum computers can be configured to perform quantum Monte Carlo integration (QMCI). In a European patent application EP22159844.4 (published as EP4053756) and in a U.S. patent application Ser. No. 17/684,254 (published as US2023/036827), which are incorporated herein by reference, various methods of quantum Monte Carlo integration are described.

Estimating the unknown amplitude of a quantum state is key to several quantum computing applications. Quantum Amplitude Estimation (QAE) provides a means to estimate this unknown amplitude, and QAE forms an important subroutine for many different applications-most notably for quantum Monte Carlo integration (QMCI).

### SUMMARY

According to a first aspect, there is provided a method for transforming a quantum algorithm to generate a plurality of quantum circuits for execution using a quantum computer, wherein the quantum algorithm utilizes a quantum-phase-estimation-free quantum amplitude-estimation algorithm for providing an estimate of an amplitude of a given quantum state, wherein the method includes:

preparing a plurality of quantum circuits for implementing amplitude estimation, wherein the preparing of a plurality of quantum circuits involves preparing a set of initial states using linear combinations of unitary quantum operations, wherein the set of initial states comprise mutually different initial states generated by rotating the given quantum state in a two-dimensional invariant subspace to each of a set of mutually different initial angles.

The plurality of quantum circuits can then be executed using a quantum computer and the results of the executions for the plurality of quantum circuits can then be processed, for example post-processing on a classical computer of the results of quantum state measurements output by the quantum computer, to provide an amplitude estimation result that combines measurement results for the plurality of initial states.

The invention is of advantage in that use of the plurality of different quantum circuits (corresponding to mutually different initial states using linear combinations of unitary quantum operations corresponding to a quantum state which has been rotated in a two-dimensional invariant subspace to different starting angles within a specified range) improves the statistical performance and robustness of quantum amplitude estimation (QAE). The invention therefore provides a technical effect in changing a way in which a computing arrangement functions and is not limited to any particular specific quantum amplitude estimation algorithm.

A quantum circuit can be generated on a classical (digital) computing apparatus and then implemented and executed on a quantum computing apparatus, for example for efficiently performing Monte Carlo Integration for various scientific computations, such as for estimation of numerical properties of physical systems. In particular, the quantum circuits can be executed on quantum computing hardware for estimating the amplitude of a quantum state, for evaluation of quantum systems.

Optionally, each initial angle is based on the weighting of the corresponding linear combination of unitary quantum operations, and the method includes specifying the weightings of the linear combinations quasi-randomly.

Optionally, each initial angle is based on the weighting of the corresponding linear combination of unitary quantum operations, and the method includes specifying the weightings of the linear combinations randomly.

Optionally, each initial angle is based on the weighting of the corresponding linear combination of unitary quantum operations, and the method includes specifying the weightings of the linear combinations deterministically.

Optionally, the method includes choosing a set of initial states with mutually different initial angles, and generating and executing a plurality of quantum circuits corresponding to the set of initial states to improve the statistical performance and robustness of a quantum amplitude estimation in terms of an improvement to at least one of: mean-squared error, skew and excess-kurtosis of the amplitude estimation.

Optionally, when using the method, the phase-estimation-free amplitude-estimation algorithm is configured to provide an estimate for an amplitude of a given quantum state, wherein the estimate is generated by performing classical post-processing for combined measurement data resulting from execution of each of a plurality of different quantum circuits that are each derived from different rotations applied to a desired quantum state. Optionally, multiple shots (executions of a quantum circuit) may be completed for each of the initial states, with each repetition implemented as a modified quantum circuit having a different number of amplitude amplification operations applied to each of the initial states, to provide further statistical robustness.

Optionally, the method includes arranging for the quantum algorithm to be transformed to be a quantum Monte Carlo integration quantum circuit. The statistically robust quantum amplitude estimation provided by the methods described in this patent specification is useful for many applications of quantum Monte Carlo integration (QMCI). A quantum-phase-estimation-free approach to QAE reduces computational cost, which is important in the NISQ era, and yet a statistically robust amplitude estimation is achieved by the performance of multiple shots using a plurality of quantum circuits corresponding to a set of mutually different initial states derived by applying mutually different rotations to a quantum state. Efficient processing is achieved by efficient allocation and implementation of computing tasks between a classical computer and a quantum computer, wherein the classical computer and the quantum computer are configured to function as a hybrid quantum computing arrangement. References to a ‘quantum computer system’ or ‘quantum computing arrangement’ herein are intended to encompass any computer system including a quantum computer, including hybrid quantum and classical systems.

According to a second aspect, there is provided a quantum circuit that is generated by using the method of the first aspect.

According to a third aspect, there is provided a quantum computing system for transforming a quantum algorithm to implement a corresponding transformed quantum circuit for execution using a quantum computer,
wherein the quantum algorithm includes a quantum phase-estimation-free quantum amplitude-estimation algorithm for providing an estimate of an amplitude of a given quantum state, wherein the quantum system is configured to:
prepare a plurality of quantum circuits for implementing the quantum amplitude estimation algorithm, wherein the preparing of a plurality of quantum circuits involves preparing a set of initial states using linear combinations of unitary quantum operations, wherein the set of initial states comprise mutually different initial states generated by rotating the given quantum state in a two-dimensional invariant subspace to each of a set of mutually different initial angles.

Optionally, each initial angle is based on the weighting of the corresponding linear combination of unitary quantum operations, and the quantum computing system is configured to specify the weightings of the linear combinations quasi-randomly.

Optionally, each initial angle is based on the weighting of the corresponding linear combination of unitary quantum operations, and the quantum computing system is configured to specify the weightings of the linear combinations randomly.

Optionally, each initial angle is based on the weighting of the corresponding linear combination of unitary quantum operations, and the quantum computing system is configured to the weightings of the linear combinations deterministically.

Optionally, in the quantum computing system, the phase-estimation-free amplitude-estimation algorithm is configured to provide an estimate for an amplitude of a given quantum state, wherein the estimate is generated by performing classical post-processing for combined measurement data resulting from a plurality of multiple shots of quantum circuits derived from a desired quantum state. More optionally, in the quantum computing system, the estimate is generated by performing classical post-processing for combined measurement data resulting from the plurality of multiple shots of mutually different quantum circuits derived from the desired quantum state, with mutually different numbers of amplitude amplification operations applied to the initial states.

Optionally, the quantum computing system is configured to arrange for the quantum algorithm to be transformed to be a quantum Monte Carlo integration quantum circuit.

According to a fourth aspect, there is provided a software product that is executable upon the quantum computing apparatus of the third aspect, to implement the method of the first aspect.

As noted above, quantum amplitude amplification is an essential subroutine for a number of applications of quantum computing. This patent specification describes a method for modifying any quantum-phase-estimation-free quantum amplitude-estimation algorithm to improve the statistical performance and robustness of the amplitude estimation. A phase-estimation-free amplitude-estimation algorithm provides an estimate for the amplitude of a desired quantum state without excessive circuit depth, and this is realised by performing classical post-processing for combined measurement data resulting from multiple executions of a number of different quantum circuits that are each derived from the desired quantum state. For further variability to provide further statistical robustness, multiple executions may be performed for each of a set of different numbers of amplitude amplification operations applied to each of a number of different initial states.

The method for modifying any quantum-phase-estimation-free algorithm prepares quantum circuits that each correspond to different initial states (chosen either pseudo-randomly, randomly or deterministically). These initial states are prepared using linear combinations of unitary operations, and correspond to states rotated in the two-dimensional invariant subspace to different starting angles within a specified range. This introduces variability to any phase-estimation-free amplitude-estimation algorithm, and will lead to improved statistical performance and robustness when considering the estimator for the amplitude. This is explicitly demonstrated by considering an example, where a phase-estimation-free amplitude-estimation algorithm is supplemented using the method, and the detailed properties of its estimator then analysed. This method is especially motivated for quantum Monte-Carlo integration (QMCI) computations, but is expected to find application in many other areas of practical use.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### DESCRIPTION OF DIAGRAMS

Example methods and systems are described below, with reference to the following diagrams:

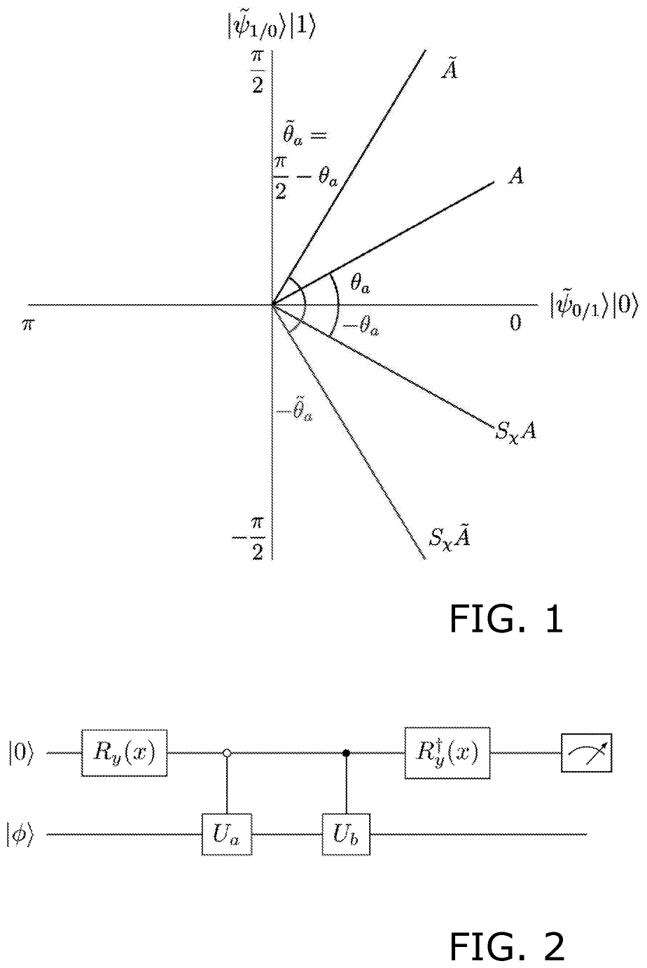

FIG. 1 shows initial rotation angles in the two-dimensional invariant subspace spanned by either |\tilde{ψ}₁ [symbol] 1 [symbol] and |\tilde{ψ}₀ [symbol] |0 [symbol] or |\tilde{ψ}₀ [symbol] 1 [symbol] and |\tilde{ψ}₁ [symbol] |0 [symbol] , corresponding to applying the unitary operators A and S_{χ}A or Ã and S_{χ}Ã, respectively.

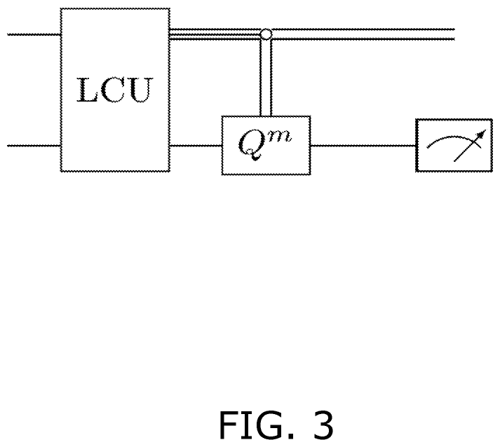

FIG. 2 shows a quantum circuit for (non-deterministically) preparing an LCU state. The desired state is prepared when the measurement outcome of the ancilla qubit is post-selected to be zero (equivalently, in practice the procedure can just be repeated until successful).

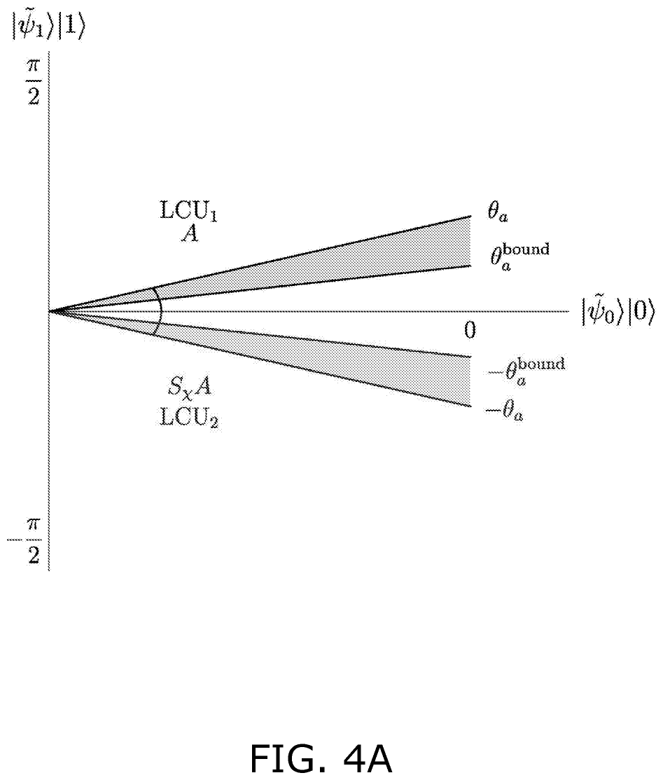

FIG. 3 shows a quantum circuit for performing QAE using LCU state preparation. The LCU block stands for the circuit given in FIG. 2, and the top wire is the post-measurement ancilla bit of this circuit.

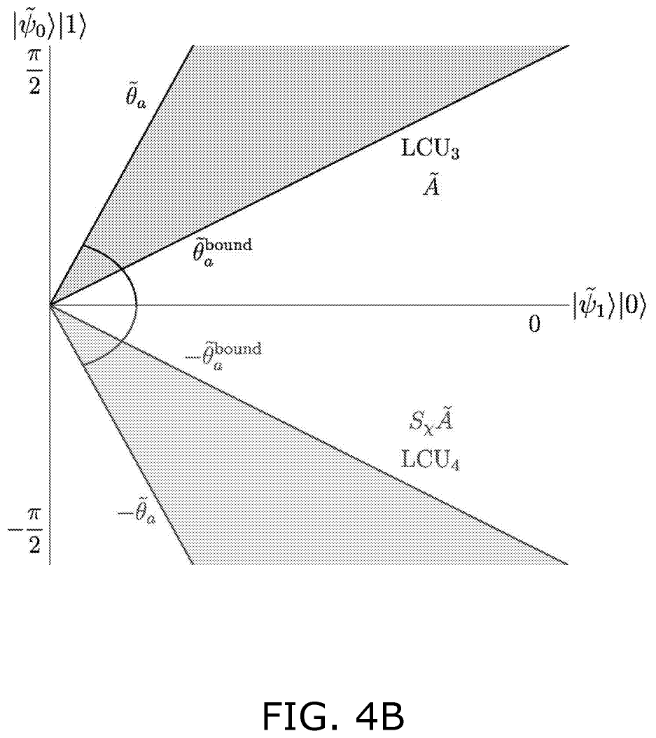

FIG. 4A shows a range of rotation angles in the two-dimensional invariant subspace spanned by |\tilde{ψ}₁ [symbol] |1 [symbol] and |\tilde{ψ}₀ [symbol] |0 [symbol] for LCUs of the operators A and S_{χ}A, corresponding to LCU categories LCU₁ and LCU₂; and

FIG. 4B shows the two-dimensional invariant subspace spanned by |\tilde{ψ}₀ [symbol] |1 [symbol] and |\tilde{ψ}₁ [symbol] |0 [symbol] for LCUs of the operators Ã and S_{χ}Ã, corresponding to LCU categories LCU₃ and LCU₄, prepared given the specific algorithm described below with reference to these figures. For illustrative purposes it is assumed that F^{bound} and the true value of θₐ are such that

$${θ}_{a}^{bound} = 0.5 {θ}_{a} .$$

The bold lines correspond to the boundaries of the sectors of the corresponding LCU categories.

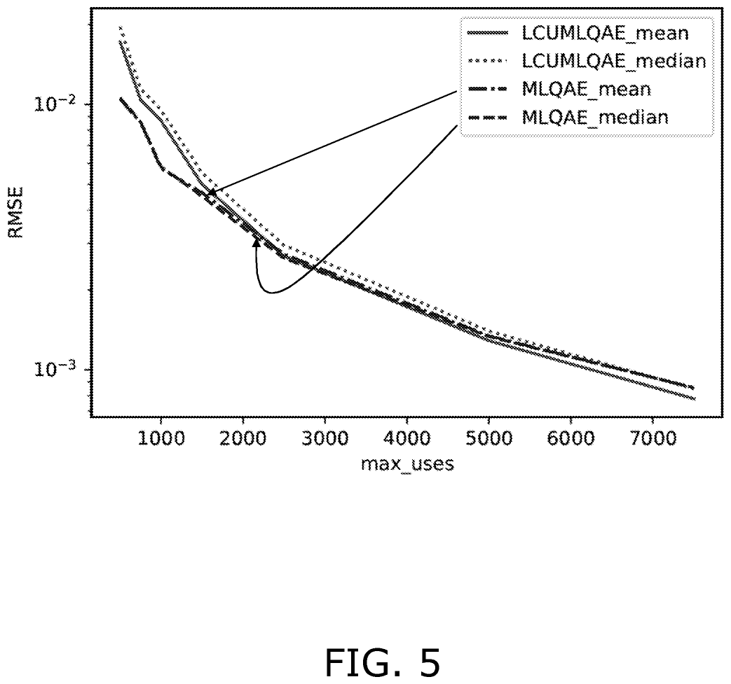

FIG. 5 is a graphical representation of square root of mean-squared-error as a function of nᵤₛₑₛ with nₛₕₒₜₛ=52, for the averaged value of 10000 simulations performed for each amplitude value, for our proposed algorithm with

$${P}_{fail}^{bound} = 0.95 ,$$

left plot averaged by mean (solid line labelled ‘LCUMLQAE_mean’) and median (small dashed line labelled ‘LCUMLQE_median’), and conventional QPE-free QAE, left plot averaged by mean (the dot and dash line ‘MLQAE_mean’) and median (large dashed line ‘MLQAE_median’).

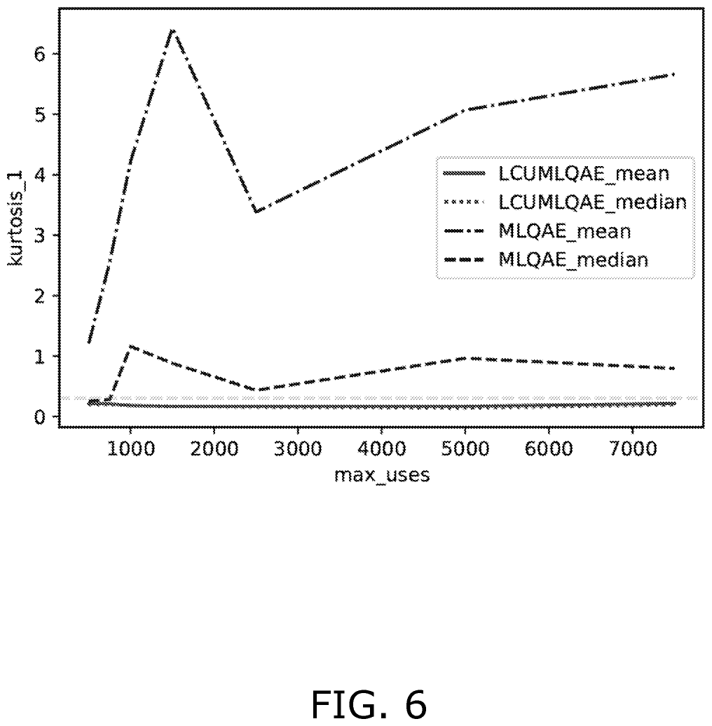

FIG. 6 shows the absolute value of excess kurtosis (kurtosis1, calculated from the fourth standardised moment of the distribution) as a function of nᵤₛₑₛ with nₛₕₒₜₛ=52, for the averaged value of 10000 simulations performed for each amplitude value for our proposed algorithm with

$${P}_{fail}^{bound} = 0.95 ,$$

left plot averaged by mean (solid line) and median (small dashed line), and conventional QPE-free QAE, left plot averaged by mean (dot and dash line) and median (large dashed line). The dashed horizontal line corresponds to 10% of the kurtosis of a unit Gaussian as calculated based on kurtosis1.

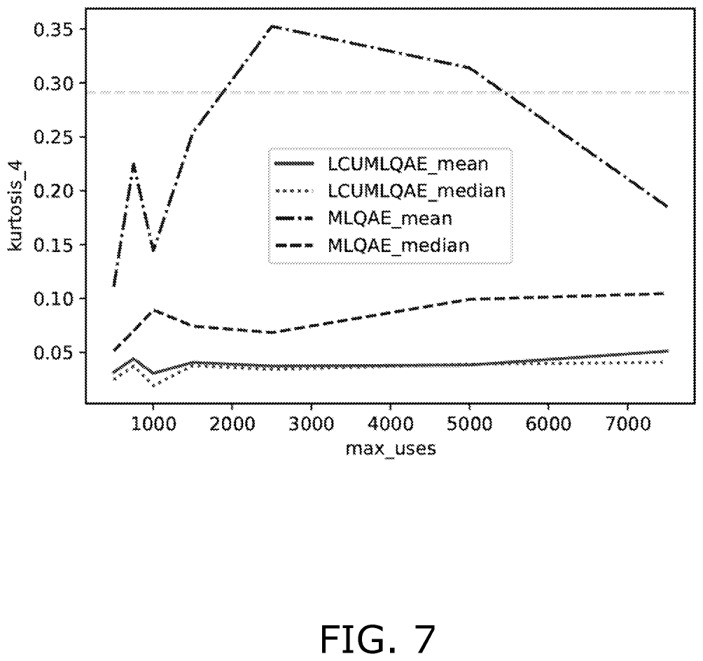

FIG. 7 shows the absolute value of excess kurtosis (kurtosis4, calculated from the quantiles of the distribution) as a function of nᵤₛₑₛ with nₛₕₒₜₛ=52, for the averaged value of 10000 simulations performed for each amplitude value for our proposed algorithm with

$${P}_{fail}^{bound} = 0.95 ,$$

left plot averaged by mean (solid line) and median (small dashed line), and conventional QPE-free QAE, left plot averaged by mean (dot and dashed line) and median (large dashed line). The dashed horizontal line corresponds to 10% of the kurtosis of a unit Gaussian as calculated based on kurtosis4.

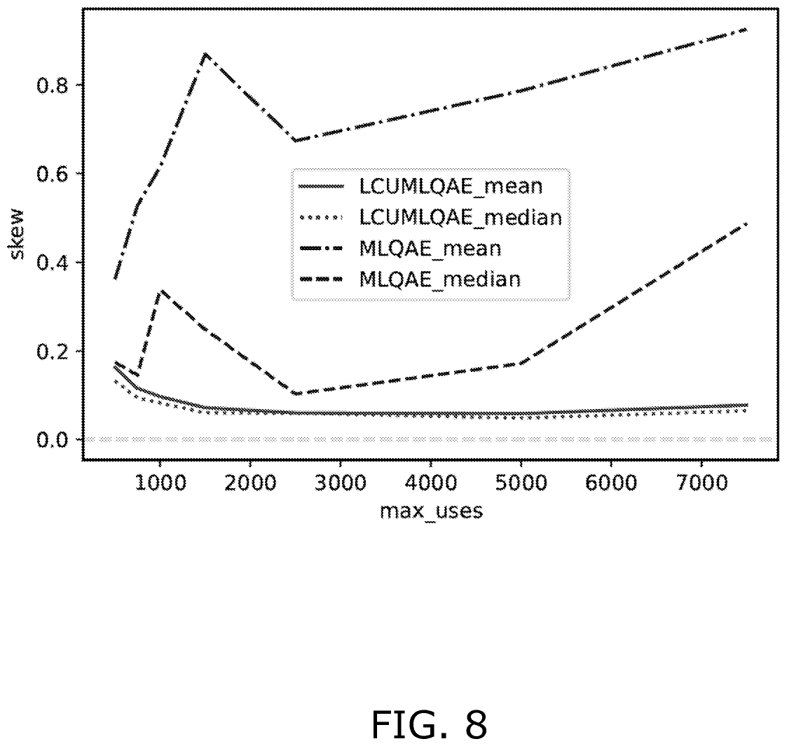

FIG. 8 shows the absolute value of skewness as a function of nᵤₛₑₛ with nₛₕₒₜₛ=52, for the averaged value of 10000 simulations performed for each amplitude value for our proposed algorithm with

$${P}_{fail}^{bound} = 0.95 ,$$

left plot averaged by mean (solid line) and median (small dashed line), and conventional QPE-free QAE, left plot averaged by mean (dot and dash line) and median (large dashed line). The dashed horizontal line corresponds to no skewness.

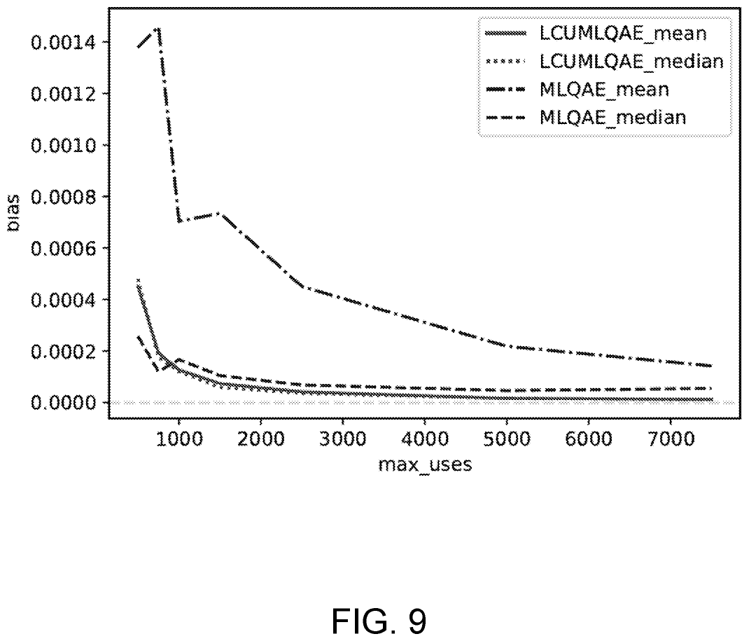

FIG. 9 shows the absolute value of bias as a function of nᵤₛₑₛ with nₛₕₒₜₛ=52, for the averaged value of 10000 simulations performed for each amplitude value for our proposed algorithm with

$${P}_{fail}^{bound} = 0.95 ,$$

left plot averaged by mean (solid line) and median (small dashed line), and conventional QPE-free QAE, left plot averaged by mean (dot and dash line) and median (large dashed line). The dashed horizontal line corresponds to no bias.

In the accompanying diagrams, an underlined number is employed to represent an item over which the underlined number is positioned or an item to which the underlined number is adjacent. When a number is non-underlined and accompanied by an associated arrow, the non-underlined number is used to identify a general item at which the arrow is pointing.

### DETAILED DESCRIPTION OF EMBODIMENTS

Embodiments of the present computer are beneficially implemented using a hybrid computing apparatus including a combination of a classical computing apparatus and a quantum computing apparatus, wherein the classical computing apparatus is coupled to the quantum computing apparatus. The classical computing apparatus provides an external portal for receiving computing tasks and outputting computational results resulting from executing the computing tasks. The classical computing apparatus performs preparatory data processing to configure quantum gates of the quantum computing apparatus to execute one or more quantum circuits that generate measurement results from the qubits of the quantum computing apparatus that are processed in the classical computing apparatus to generate the aforesaid computational results to be output from the external portal or retained within the hybrid computing apparatus for use in later computations. Embodiments of the present disclosure make particularly effective use of the quantum computing apparatus, and therefore shift computation workload from the classical computing apparatus to the quantum computing apparatus. The quantum computing apparatus can be implemented using ion-trap devices, photonics devices, cryogenic superconducting gate technology, but is not limited to these implementation options.

### 1 Introduction and Motivation

Estimating the unknown amplitude of a quantum state is key to several quantum computing applications, because when said state is measured in the computational basis, a given bitstring is sampled with probability equal to the squared amplitude of the corresponding term when the state is expressed as a superposition of computational basis states. Quantum amplitude estimation (QAE) algorithms provide a means to estimate this unknown amplitude, and QAE subsequently forms an essential subroutine for many different applications-most notably for quantum Monte Carlo (MC) integration [1, 2].

The original proposed algorithm for QAE [3] made use of the quantum Fourier transform, and whilst the quantum Fourier transform does not pose a problem in terms of asymptotic performance, it is likely to be prohibitively computationally costly in the near term. This has led to the development of alternative algorithms such as amplitude estimation without quantum phase estimation (QPE-free) [4] and other related proposals [5, 6], all of which rely on classical post-processing to return the estimate.

The performance of a given QAE algorithm has typically been judged in terms of the mean-squared error (MSE) returned by the estimator for the amplitude. As a function of the number of quantum queries or the number of classical samples (both denoted as q), then QAE provides a MSE that can scale up to [symbol] (q⁻²) (termed ‘quadratic advantage’, although note that not all QPE-free QAE implementations achieve this full advantage) with the number of queries as compared to classical methods, which scale as [symbol] (q⁻¹).

Whilst MSE convergence gives an indication as to general performance, it does not fully describe the statistical properties and robustness of the estimator. In particular, the kurtosis-a measure of the ‘tailedness’ of the probability distribution for the estimator, and therefore for the propensity to produce outliers—is an important property for potential applications of QAE that are sensitive to non-bulk performance of the estimator, such as in finance where rare events can carry great importance [7]. In practice the excess kurtosis (relative kurtosis as compared to a unit Gaussian) is often studied, noting that a Gaussian distribution approximates a binomial distribution for sufficient sample size—given the Central Limit Theorem—one would not expect smaller kurtosis for the estimator than for a unit Gaussian.

In addition, other related properties such as the skewness of the distribution for the estimator are important. In this specification, we propose a novel method for modifying any QPE-free QAE algorithm to improve the robustness, and this is implemented by making use of a linear combinations of unitary (LCU) operations. Note that the methods laid out in this specification are generally applicable and can be utilised regardless of the specific implementation. However, in particular, in this specification we also discuss one such novel implementation based on such an approach, which results in an estimator for the amplitude that not only performs competitively when considering MSE, but also appears asymptotically unbiased and exhibits near-Gaussian kurtosis and skewness; this demonstrates the robustness of the general procedure as compared to standard QPE-free QAE implementations. In this specification, representative performance plots for this specific algorithm—extracted from MC simulations—are used to demonstrate this. In addition, as far as we are aware, this represents the first time that the statistical properties and robustness of a QAE algorithm have been analysed in this manner.

### 2 Overview of Proposed Method

QAE makes use of quantum amplitude amplification—a generalisation of Grover's search algorithm [9]—to provide quantum advantage. This is formulated by considering an unitary operator A that prepares an initial (n+1)-qubit state as

$${\vert ψ 〉 ≡ A \vert 0 〉}^{⊗ ( n + 1 )} = \sqrt{1 - a} \vert {\tilde{ψ}}_{0} 〉 \vert 0 〉 + \sqrt{a} \vert {\tilde{ψ}}_{1} 〉 \vert 1 〉 , \qquad ( 1 )$$

where a represents the amplitude of the state (the parameter to be estimated) and \tilde{ψ}₀ and \tilde{ψ}₁ are n-qubit (normalised) states. Amplitude amplification then consists of amplifying the probability of measuring the one state by applying the following operator to ψ

$$Q ≡ - {AS}_{0} {A}^{†} {S}_{χ} , \qquad ( 2 )$$

where A^{†} is the inverse of A and S_{χ} is a unitary operator which acts as

$${S}_{χ} \vert {\tilde{ψ}}_{1} 〉 \vert 1 〉 = - \vert {\tilde{ψ}}_{1} 〉 \vert 1 〉 , {S}_{χ} \vert {\tilde{ψ}}_{0} 〉 \vert 0 〉 = \vert {\tilde{ψ}}_{0} 〉 \vert 0 〉 , \qquad ( 3 )$$

whilst S₀ also does not depend on A.

By defining the parameter θₐ∈[0, π/2] such that sin² (θₐ)=a, then one can write

$$ψ = cos ( {θ}_{a} ) \vert {\tilde{ψ}}_{0} 〉 \vert 0 〉 + sin ( {θ}_{a} ) \vert {\tilde{ψ}}_{1} 〉 \vert 1 〉 , \qquad ( 4 )$$

which demonstrates that applying the operator A can be considered as a rotation by an angle θₐ in the two-dimensional invariant subspace spanned by |\tilde{ψ}₁ [symbol] |1 [symbol] and |\tilde{ψ}₀ [symbol] |0 [symbol] Similarly, it can be shown that applying Q (m times) to |v) yields

$${Q}^{m} \vert ψ 〉 = cos ( ( 2 m + 1 ) {θ}_{a} ) \vert {\tilde{ψ}}_{0} 〉 \vert 0 〉 + sin ( ( 2 m + 1 ) {θ}_{a} ) \vert {\tilde{ψ}}_{1} 〉 \vert 1 〉 , \qquad ( 5 )$$

such that each application of Q further rotates the state by an additional 2θₐ. Thus the state can be rotated to any (odd) integer multiple of θₐ in this manner, providing the amplitude amplification.

However, the condition that the initial rotation is by exactly θₐ limits the overall variation in the algorithm; one typically finds that for certain values of θₐ the performance of QAE is limited, for example if the rotation always results in a state that lies close to the principal axes of the invariant subspace.

Our proposed method for modifying any QPE-free QAE algorithm overcomes this limitation by instead initialising a new state |Ψ [symbol] with a rotation to an angle α in the same subspace. Using (3), then

$${{S}_{χ} A \vert 0 〉}^{⊗ ( n + 1 )} = cos ( {θ}_{a} ) \vert {\tilde{ψ}}_{0} 〉 \vert 0 〉 - sin ( {θ}_{a} ) \vert {\tilde{ψ}}_{1} 〉 \vert 1 〉 , \qquad ( 6 )$$

such that the state is instead rotated by an angle −θₐ. In addition consider the operator

$$Ã ≡ ( ⊗ {σ}_{x} ) A , \qquad ( 7 )$$

where [symbol] is the 2ⁿ×2ⁿ identity matrix and σₓ is a Pauli operator; this operator thus has the affect of applying a single Pauli-X rotation to the (n+1)^{th} qubit, which results in a state rotated in a conjugate invariant subspace spanned by |\tilde{ψ}₀ [symbol] 1 [symbol] and |\tilde{ψ}₁ [symbol] |0 [symbol] by an angle \tilde{θ}ₐ=π/2−θₐ. S_{χ}Ã will thus rotate the state by an angle −\tilde{θ}ₐ. Hereafter Θₐ will be used sometimes to refer generally to either θₐ or \tilde{θ}ₐ.

FIG. 1 demonstrates the diversity of initial angles that can be achieved using these simple operators. FIG. 1 shows initial rotation angles in the two-dimensional invariant subspace spanned by either |\tilde{ψ}₁ [symbol] |1 [symbol] and |\tilde{ψ}₀ [symbol] |0 [symbol] or |\tilde{ψ}₀ [symbol] |1 [symbol] and |\tilde{ψ}₁ [symbol] |0 [symbol] corresponding to applying the unitary operators A and S_{χ}A or Ã and S_{χ}Ã, respectively. The labelled lines correspond to the ranges of each sector.

An LCU—corresponding to weighted linear sums of either A and S_{χ}A or Ã and S_{χ}Ã, as these two pairs setup in distinct invariant subspaces based on either A or Ã as discussed—can thus be constructed, which when applied to the state |0 [symbol] will result in an initial state rotated by α. The general form of this (un-normalised) state is

$$\vert Ψ 〉 = cos ( {Θ}_{a} ) \vert {\tilde{ψ}}_{0 / 1} 〉 \vert 0 〉 + F sin ( {Θ}_{a} ) \vert {\tilde{ψ}}_{1 / 0} 〉 \vert 1 〉 , \qquad ( 8 )$$

where −1≤F≤1 and

$$α = {tan}^{- 1} ( F tan ( {Θ}_{a} ) ) . \qquad ( 9 )$$

There are four possible categories of LCU initial states that can be prepared (referred to as LCU₁₋₄ for brevity, respectively), each corresponding to rotating the state to within a different angular range bounded by some

$${Θ}_{a}^{b o u n d}$$

(this is defined later):

$$\begin{matrix}LC {U}_{1} ( x ) : & {cos}^{2} ( x / 2 ) A + {sin}^{2} ( x / 2 ) {S}_{χ} A , & {θ}_{a}^{b o u n d} \leq α \leq {θ}_{a} , \\ LC {U}_{2} ( x ) : & {cos}^{2} ( x / 2 ) {S}_{χ} A + {sin}^{2} ( x / 2 ) A , & - {θ}_{a} \leq α \leq - {θ}_{a}^{b o u n d} , \\ LC {U}_{3} ( x ) : & {cos}^{2} ( x / 2 ) Ã + {sin}^{2} ( x / 2 ) {S}_{χ} Ã , & {\tilde{θ}}_{a}^{b o u n d} \leq α \leq {\tilde{θ}}_{a} , \\ LC {U}_{4} ( x ) : & {cos}^{2} ( x / 2 ) {S}_{χ} Ã + {sin}^{2} ( x / 2 ) Ã , & - {\tilde{θ}}_{a} \leq α \leq - {\tilde{θ}}_{a}^{b o u n d} ,\end{matrix} \qquad ( 10 )$$

where x=cos⁻¹(F).

FIG. 2 demonstrates the form of the quantum circuit used to perform LCU state preparation. The procedure uses an additional ancilla qubit, as is standard for LCU state preparation. The desired state is prepared when the measurement outcome of the ancilla qubit is post-selected to be zero (equivalently, in practice the procedure could just be repeated until successful). In the circuit of FIG. 2, Uₐ and U_{b} are either drawn from the pair A and S_{χ}A or the pair Ã and S_{χ}Ã, as discussed previously, and R_{y}(x) is a single-qubit rotation through the y-axis of the Bloch sphere by the angle x. Such a circuit results in the state

$$\vert 0 〉 \vert ϕ 〉 \to \vert 0 〉 {\overbrace{( {cos}^{2} ( x / 2 ) {U}_{a} + {sin}^{2} ( x / 2 ) {U}_{b} ) \vert ϕ 〉}}^{Ψ} + \vert 1 〉 {\overbrace{\frac{1}{2} sin ( x ) ( {U}_{b} - {U}_{a} ) \vert ϕ 〉 ,}}^{\hat{Ψ}} \qquad ( 11 )$$

where |Ψ [symbol] or |\hat{Ψ} [symbol] refers to the post-measurement state of the second register and
   |Ψ [symbol] ≡(cos²(x/2)Uₐ+sin²(x/2)U_{b})|ϕ [symbol] corresponds to the desired state, as discussed.

A recognised limitation of this implementation of the LCU state preparation is that post-selection on the ancilla qubit is used to prepare the correct state (corresponding to measuring 0), and thus there is a probability that the LCU state preparation will fail. This probability is

$${P}_{fail} = \frac{1}{4} {sin}^{2} ( x ) {‖ {U}_{b} - {U}_{a} ‖}^{2} = {sin}^{2} ( x ) . \qquad ( 12 )$$

P_{fail} can be upper bounded by some

$${P}_{fail}^{b o u n d} ,$$

set by constraining the range of the rotation parameter x as

$$0 \leq x \leq {sin}^{- 1} ( \sqrt{{P}_{fail}^{b o u n d}} ) ;$$

this corresponds to the weighting of the two terms Uₐ and U_{b} in (11), defining a bound (either upper or lower) on the factor F in (8), F^{bound}, and thus indirectly the rotated angle of the initial state, which is then bounded (equivalently either upper or lower) by

$${Θ}_{a}^{b o u n d} = {tan}^{- 1} ( \sqrt{1 - {P}_{fail}^{b o u n d}} tan ( {Θ}_{a} ) ) ,$$

as discussed previously. Note that it is impossible to prepare an equal superposition of Uₐ and U_{b}, which would correspond to an initial angle of α=0 in our case, as then P_{fail}=1.

Our proposed method for modifying any QPE-free QAE algorithm thus utilises different LCU state-preparation circuits to prepare initial states with different F values (either chosen quasi-randomly, randomly or deterministically) and therefore different starting angles, and then conditioned on post-selection (i.e. that the LCU state preparation was successful) a given number of Grover iterations as standard are applied to those initial states to perform amplitude amplification. This is then followed by classical post-processing to estimate the amplitude, which for example could be realised by performing maximum-likelihood estimation for combined measurement data resulting from each run of QAE, as is done for the specific algorithm described in Section 4 below.

FIG. 3 shows a combined quantum circuit for performing the described QAE procedure-consisting of LCU state-preparation circuit and Grover iterations. The LCU block represents the circuit of FIG. 2 and the top wire is the post-measurement ancilla bit of this circuit. It is important to note that the zero conditioning on the ancilla qubit for this circuit means that Grover iterations are not applied when the post-selection fails. However, in general the principle of deferred measurement can be invoked to give an equivalent circuit where these measurements are performed in the final layer, if desired. A general outline of the technical detail and steps of the method are described in the following section.

### 3 General Technical Detail and Steps of the Method

Our proposed method is a general method for modifying any QPE-free QAE algorithm—by introducing LCU state preparation—in order to improve the statistical properties and robustness of the estimator for the amplitude (or equivalently for θₐ).

Any QPE-free algorithm can be formulated as an instance of the generic framework given in Algorithm 1 below. Going into further detail, ‘Stopping Criterion’ could be, for example, the desired accuracy of the estimate, total wall-clock time, total number of uses of A etc; the estimator â could be any estimator, for example, maximum-likelihood, minimum mean-squared error etc. Optionally, following each shot p(θₐ) could be updated and the Stopping Criterion could also be assessed. Note that this general approach is also the same for any noise-aware QAE algorithm (i.e. QAE with an embedded noise model) such as the one described in [10].

Algorithm 1 Generic algorithm for any QPE-free QAE.

Require: Quantum circuit A; posterior distribution p(θₐ) initiated with a set of priors; Stopping

| | Criterion |
|---|---|
| 1: | Set m, nₛₕₒₜₛ, (optional) additional parameters |
| 2: | Prepare and measure nₛₕₒₜₛ of Q^{m} A \|0 [symbol] |
| 3: | Update p(θₐ) using measurement outcomes based on standard probabilistic procedures |
| 4: | if Stopping Criterion is met then |
| 5: | Return â (or \hat{θ}ₐ) |
| 6: | else Update m, nₛₕₒₜₛ; Goto Line 2 |
| 7: | end if |

Now we discuss the modification of this general framework to include LCU state preparation. We first note that the general principle of using LCU state preparation to prepare an initial state (the state prior to performing amplitude amplification) |Ψ [symbol] with a quasi-randomly, randomly or deterministically specified F factor (i.e. corresponding to a rotation to an angle in the same subspace) is only relevant for non-trivial applications of the Grover iterate in (2) (m>0), as there is no advantage to be gained for m=0.

Each stage of the generic framework for QPE-free QAE is thus modified as follows:
1. An additional parameter of the method that is set is

$${θ}_{a}^{b o u n d}$$

(which then also defines

$${\tilde{θ}}_{a}^{bound} ) ,$$

however this cannot be set directly as it a function of the unknown θₐ, as demonstrated in (9), therefore we instead set F^{bound} (or equivalently

$${P}_{fail}^{bound}$$

can be chosen, as the two are trivially related). This choice restricts the angular range of the sectors of the invariant subspace corresponding to the four different categories of LCU state-preparation circuits given in (10), thereby restricting the diversity in the possible initial angles; however, conversely a larger angular range means a larger

$${P}_{fail}^{bound} ,$$

such that the LCU state preparation will fail more often, on average.
2. For m=0, this step is unchanged. However, for m>0, then LCU state preparation can be exploited to improve the performance of any QPE-free QAE algorithm, by initialising |Ψ [symbol] to a specified F before Grover iterations are applied. This requires p(θₐ) to be updated after each shot (i.e. for each shot Step 3 follows Step 2) and—given that the state preparation is non-deterministic—then it can be necessary in some instances—depending on the choice of criterion—to also check the Stopping Criterion following each shot or each LCU state-preparation attempt (i.e. for each, Step 4 follows), as discussed later. Given a chosen nₛₕₒₜₛ, these shots can be assigned in any chosen manner to prepare each of the four different categories of circuit LCU₁₋₄ (or even only a subset of the possible categories if desired, the important point is that there is a variability in the starting angle for each shot). However, given the total number of categories, it is recommended to choose nₛₕₒₜₛ to be a multiple of four, such that shots are assigned equally to prepare each of the four different categories (nₛₕₒₜₛ/4 each) to introduce maximal variability. Each shot within a given category is prepared to give a different initial starting angle within that sector of the invariant subspace (i.e. within the corresponding specified range given in (10)), by specifying the value of the x parameter for the corresponding quantum circuit. The sample of initial angles to prepare for all shots within a given sector can be indirectly chosen in either a quasi-random, random or deterministic manner: in the first case, this may be done based on a low-discrepancy sequence (which takes values between 0 and 1 that can then be mapped onto the specified range to give the values of F) such as the Van der Corput sequence (VdCS); in the second case, this may be achieved by sampling uniformly within the available range of F; and in the final case, this may be achieved by choosing equally spaced points in the range. However, we note that the quasi-random implementation is the preferred choice, as for a low number of shots random sampling may not result in a representative, low-discrepancy sample. If the LCU state preparation fails, then before applying Grover iterates the circuit can be repeated until the correct state is prepared (otherwise this particular circuit can be skipped for the next one based on some other condition). Note that this means that QAE with LCU state preparation has low resource overhead as it would ‘fail quickly’ if the post-selection condition is not met. In order to ensure that the different categories of LCU state-preparation circuits are utilised as evenly as possible—to give maximal variability—then it is preferred that each subsequent shot of QAE should prepare a different category of circuit.
3. Standard probabilistic procedures can still be used to update p(θₐ), as the initial starting angle for a given shot α is known as a function of the unknown θₐ. This is done after every shot, as the initial angle differs each time.
4. As there is generally a non-zero probability that the LCU state preparation will fail—conservatively, at worst one expects to have to run the LCU state preparation

$${n}_{exp} = {( 1 - {P}_{fail}^{bound} )}^{- 1}$$

times before the correct state is prepared—then depending on the choice of Stopping Criterion (i.e. if there is a hard bound on the total number of uses of A or Ã regardless of the LCU state preparation post-selection) it may be that the Stopping Criterion is in effect met midway through a shot.

The proceeding steps of the generic algorithm remain unchanged.

For the sake of definiteness, in the following two sections we give an explicit example implementing the method, where a QPE-free QAE algorithm is supplemented with LCU state preparation, and demonstrate its improved performance as compared to the nominal version.

### 4 a Specific Algorithm Implementing the Method

An explicit algorithm for QPE-free QAE supplemented with LCU state preparation is now discussed, given a specified

$${P}_{fail}^{bound} ,$$

a bound on the maximal number of excess uses of either circuit A or Ã, denoted nᵤₛₑₛ, (this can be defined as either successful uses i.e. after successful post-selection—which is default—or as all uses regardless of the post-selection result; in each case the algorithm will behave differently, as will be discussed) and a given number of desired shots to run for of each power of the Grover iterate in (2), nₛₕₒₜₛ.

This algorithm allows us to prepare an initial state (the state prior to performing amplitude amplification) |Ψ [symbol] with a quasi-random F factor i.e. rotated to an angle α=tan⁻¹(F tan(Θₐ)) in the same subspace, before amplitude amplification and then classical post-processing are applied in order to estimate the amplitude.

The algorithm allocates all available shots of QAE (nₛₕₒₜₛ is forced to be a multiple of four as previously discussed) in order to introduce maximal variability; this ensures strong and robust performance for any θₐ value.

p(θₐ) is in principle continuous, however the probability has to be represented in some way, and therefore, by convention, a discrete (approximate) representation for p(θₐ) is chosen; in this algorithm, a grid of evenly spaced θₐ values in the range θₐ∈[0, π/2] and a corresponding grid of points of probability mass are initialised—the latter set uniformly (however, we note that in principle any prior can be set on p(θₐ)). Following each shot of QAE, the corresponding measurement data is used to update p(θₐ) using Bayes' law, and after nᵤₛₑₛ of QAE have been exhausted, the estimate for the amplitude is obtained, based on the final p(θₐ).

When running iterations of QAE to produce the measurement data, a schedule for powers of the Grover iterate applied at each iteration is used, where this follows a so-called exponentially increasing sequence (EIS) (m∈{0,1,2,4,8,16, . . . }) where possible. The maximum value of m depends on nᵤₛₑₛ (and the running performance of the algorithm depending on how nᵤₛₑₛ is defined), as will be discussed. Because nᵤₛₑₛ is bounded, following each shot of QAE, the remaining number of uses is used by the algorithm to decide how best to allocate remaining shots.

Initially, assuming nᵤₛₑₛ≥1.5nₛₕₒₜₛ, then 1.5nₛₕₒₜₛ uses are allocated to m=0, where no LCU state preparation is used in this case as no amplitude amplification is performed. Then, for all subsequent powers m>0, LCU state preparation is implemented to initialise Ψ to a specified F before Grover iterations are applied.

However, one caveat is that there is a probability that the LCU state preparation will fail, as discussed previously, and this is bounded by the specified

$${P}_{fail}^{bound} .$$

Thus for a given value of m, the expected number of uses for a single shot of QAE is 2(m+nₑₓₚ). This is because each power of the Grover iterate and each LCU state preparation circuit for a given shot correspond to two uses of the circuit A or A each, respectively. As this is non-deterministic, then there are two possible methods of running the algorithm, dependent on how nᵤₛₑₛ is defined:
1. (Default) if nᵤₛₑₛ is defined to be those with successful post-selection, then the algorithm will simply run the full schedule until complete, where the true number of uses which be larger than the requested nᵤₛₑₛ.
2. (Optional) if nᵤₛₑₛ is defined to be all uses, then if after any (attempted) shot all nᵤₛₑₛ are exhausted (hereafter referred to as Stopping Criterion 1), the algorithm will simply return the current best estimate for the amplitude.

For reasons of simplicity as previously mentioned, nₛₕₒₜₛ is constrained in the algorithm to be a multiple of four, so that the shots are assigned equally to prepare each of the four different categories. Then for each shot within a given category, a state with a different starting angle is prepared. The starting angles are chosen indirectly by choosing F factors in a quasi-random way, based on the VdCS; nₛₕₒₜₛ/4 elements of the VdCS are generated, which take values between 0 and 1, and these are then mapped onto the specified range, leading to a low-discrepancy (quasi-random) sample of F values within the range. FIG. 4 gives an illustrative example of the sample of initial angles prepared using this approach when nₛₕₒₜₛ=8 and (for illustrative purposes) it is assumed that F^{bound} and the true value of θₐ are such that

$${θ}_{a}^{bound} = 0.5 {θ}_{a} .$$

FIGS. 4A and 4B show ranges of rotation angles. FIG. 4A shows this in the two-dimensional invariant subspace spanned by |\tilde{ψ}₁ [symbol] 1 [symbol] and |\tilde{ψ}₀ [symbol] 0 [symbol] for LCUs of the operators A and S_{χ}A, corresponding to LCU categories LCU₁ and LCU₂. FIG. 4B shows the two-dimensional invariant subspace spanned by |\tilde{ψ}₀ [symbol] |1 [symbol] and |\tilde{ψ}₁ [symbol] |0 [symbol] for LCUs of the operators Ã and S_{χ}Ã, corresponding to LCU categories LCU₃ and LCU₄, prepared given the specific algorithm described in this section. For illustrative purposes it is assumed that F^{bound} and the true value of θₐ are such that

$${θ}_{a}^{bound} = 0.5 {θ}_{a} .$$

The bold lines correspond to the boundaries of the sectors of the corresponding LCU categories. Note that if one subspace has a tight range of angles, the other will have a large range.

If the LCU state preparation fails, then the algorithm reruns that circuit until the correct state is prepared (assuming that Stopping Criterion 1 is still not met if it has been optionally set). In addition, in order to ensure that the four different categories of LCU state-preparation circuits are utilised as evenly as possible, then the algorithm ensures that each subsequent shot of QAE prepares a different category. Overall, this approach maximises the variability in the possible starting angle of each shot of QAE.

This process is repeated in increasing powers of m in the EIS until (hereafter referred to as Stopping Criterion 2) the remaining number of uses is less than 2(m+2)nₛₕₒₜₛ, or 2(m+nₑₓₚ)nₛₕₒₜₛ if nᵤₛₑₛ is defined as all uses. After this, the algorithm then looks for the largest m value between the current value in the EIS and the proceeding one such that a full nₛₕₒₜₛ of LCU QAE can be run,

$${m}^{*} = floor ( \frac{1}{2} ( \frac{remaininguses}{{n}_{shots}} - 2 ) ) , \\ or {m}^{*} = floor ( \frac{1}{2} ( \frac{remaininguses}{{n}_{shots}} - {n}_{exp} ) )$$

if nᵤₛₑₛ is defined as all uses. nₛₕₒₜₛ of LCU QAE with m=m* is then run.

If nᵤₛₑₛ is defined as successful uses (as default), then the algorithm cycles down the given set of m values and checks for each whether the remaining number of uses is greater than 2m+2 (hereafter referred to as PassingCriterion1), and if the condition is met for a given m, then remaininguses/(2m+2) (rounded down to the nearest multiple of four) shots of QAE with LCU state preparation are performed. Finally, the algorithm cycles down the given set of m values and checks for each whether the remaining number of uses is greater than 2m+1 (hereafter referred to as PassingCriterion2), corresponding to the number of uses of A for a given shot of QAE without LCU state preparation. If the condition is met for a given m, then remaininguses/(2m+1) (rounded down) shots of QAE without LCU state preparation are performed. This ensures that all nᵤₛₑₛ are exhausted.

The estimate for θₐ is then determined based on a minimum mean-squared error estimator (dot product of the grid of θₐ values with p(θₐ)), and the estimate for the amplitude, â, is then returned from this.

The algorithm can be enumerated as given in Algorithm 2 below.

Algorithm 2
Algorithm for QAE with LCU state preparation.

Require: Quantum circuit A; posterior distribution p(θₐ) initiated with a set of priors; (optional) Stopping

| | Criterion 1; Stopping Criterion 2; (default but optional) Passing Criterion 1; Passing Criterion 2 |
|---|---|
| 1: | $Set m = 0 , {n}_{uses} ( and how it is defined ) , {n}_{shots} , {P}_{fail}^{bound}$ |
| 2: | Prepare and measure 1.5ₙ_{ₛₕₒₜₛ} of Q^{m=0}A \|0 [symbol] |
| 3: | Update p(0ₐ) using measurement outcomes |
| 4: | Update m to next value in EIS |
| 5: | $Calculate {n}_{shots} / 4 elements of the scaled VdCS ( based on {P}_{fail}^{bound} )$ |
| 6: | while (optional) Stopping Criterion 1 is not met do |
| 7: | while Stopping Criterion 2 is not met do |
| 8: | for j ← 1 to nₛₕₒₜₛ/4 do |
| 9; | for i ← 1 to 4 do |
| 10: | Prepare a shot of Q^{m}LCUᵢ(x) \|0 [symbol] (x chosen based on the j^{th} element of the VdCS) |
| 11: | if LCU state preparation fails then |
| 12: | Goto Line 10 |
| 13: | else Measure and update p(θₐ) using measurement outcome |
| 14: | end if |
| 15: | end for |
| 16: | end for |
| 17: | Update m to next value in EIS; Goto Line 8 |
| 18: | end while |
| 19: | Update m to m* |
| 20: | for j ← 1 to nₛₕₒₜₛ/4 do |
| 21: | for i ← 1 to 4 do |
| 22: | Prepare a shot of Q^{m}LCUᵢ(x) \|0 [symbol] (x chosen based on the j^{th} element of the VdCS) |
| 23: | if LCU state preparation fails then |
| 24: | Goto Line 22 |
| 25: | else Measure and update p(θₐ) using measurement outcome |
| 26: | end if |
| 27: | end for |
| 28: | end for |
| 29: | if (default but optional) Passing Criterion 1 is met then |
| 30: | $for j ← 1 to 4 \times floor ( \frac{remaining uses}{2 m + 2} / 4 ) do$ |
| 31: | for i ← 1 to 4 do |
| 32: | Prepare a shot of Q^{m}LCUᵢ(x) \|0 [symbol] (x chosen based on the j^{th} element of the VdCS) |
| 33: | if LCU state preparation fails then |
| 34: | Goto Line 32 |
| 35: | else Measure and update p(θₐ) using measurement outcome |
| 36: | end if |
| 37: | end for |
| 38: | end for |
| 39: | if m > 0 then |
| 40: | Update m to previous value in sequence; Goto Line 29 |
| 41: | else Goto Line 49 |
| 42: | end if |
| 43: | else |
| 44: | if m > 0 then |
| 45: | Update m to previous value in sequence; Goto Line 29 |
| 46: | else Goto Line 49 |
| 47: | end if |
| 48: | end if |
| 49: | Update m to m* |
| 50: | if Passing Criterion 2 is met then |
| 51: | $Prepare and measure floor ( \frac{remaining uses}{2 m + 1} ) shots of {Q}^{m} A \text{\textbar 0} 〉$ |
| 52: | Update p(θₐ) using measurement outcomes |
| 53: | if m > 0 then |
| 54: | Update m to previous value in sequence; Goto Line 50 |
| 55: | else Goto Line 64 |
| 56: | end if |
| 57: | else |
| 58: | if m > 0 then |
| 59: | Update m to previous value in sequence; Goto Line 50 |
| 60: | else Goto Line 64 |
| 61: | end if |
| 62: | end if |
| 63: | end while |
| 64: | Return â |

Note
that the ‘while loops’ in fact check for relevant conditions after each shot of QAE, rather than at the end of the loop as implied here; they are merely written in this way for illustrative purposes.

### 5 Performance of the Specific Algorithm

In order to demonstrate the performance of the algorithm described in Section 4 as regards the statistical properties of the estimator for the amplitude, simplified MC simulations are performed based on the full algorithm, for a range of nᵤₛₑₛ (with nₛₕₒₜₛ=52 and

$${P}_{fail}^{bound} = 0.95 )$$

and over a range of values of the amplitude (where the average performance across the range is also determined).

For each simulation it is assumed that the LCU state preparation works perfectly every time, such that each shot always successfully measures the state and updates p(θₐ) accordingly (i.e. nᵤₛₑₛ is defined as successful uses). Note that the additional overhead one would accrue when accounting for the non-zero failure probability of the LCU state preparation is minimal, therefore a direct comparison with conventional QPE-free QAE is still valid in this case. For simplicity only QAE with LCU state preparation is considered (i.e. when filling down nominal QAE shots are not considered). Any excess shots are then used for m=0 non-amplitude-amplification measurements.

For a given value of nₛₕₒₜₛ, 10000 simulations are run for each value of the amplitude, and the square root of the MSE (RMSE), excess kurtosis (in fact two different methods of calculating excess kurtosis are employed: kurtosis1, which is the standard definition, calculated from the fourth standardised moment of the distribution—and thus can be sensitive to one-or-more large outliers in data—and kurtosis4, which is instead calculated based on quantiles of the distribution and is therefore more robust to outliers [11]), skewness and bias of the distribution for the amplitude are determined. Bootstrapping is used to determine the uncertainties on the data points. These values are then also averaged across all amplitude values based on both the mean and median. Given the asymmetric uncertainties on the per-amplitude distributions, and the difficulty in propagating the uncertainties for the averaged distributions, error bars are omitted.

FIGS. 5-9 give the average values for each amplitude as a function of nᵤₛₑₛ for RMSE, excess kurtosis (kurtosis1 and kurtosis4), skewness and bias, respectively, for our specific algorithm and for conventional QPE-free QAE based on allocating shots according to an EIS; the strong performance and robustness of our algorithm is clear to see.

FIG. 5 shows the square root of mean-squared error as a function of nᵤₛₑₛ with nₛₕₒₜₛ=52, for (left) the averaged value of 10000 simulations performed for each amplitude value and (right) 10000 simulations for each amplitude value individually, for (red, triangles for right plot) our proposed algorithm with

$${P}_{fail}^{bound} = 0.95 ,$$

left plot averaged by (solid line) mean and (small dashed line) median, and (blue, circles for right plot) conventional QPE-free QAE, left plot averaged by (solid and dashed line) mean and (large dashed line) median.

FIG. 6 shows the absolute value of excess kurtosis (kurtosis1, calculated from the fourth standardised moment of the distribution) as a function of nᵤₛₑₛ with nₛₕₒₜₛ=52, for the averaged value of 10000 simulations performed for each amplitude value for our proposed algorithm with

$${P}_{fail}^{bound} = 0.95 ,$$

left plot averaged by mean (solid line) and median (small dashed line), and conventional QPE-free QAE, left plot averaged by mean (dot and dash line) and median (large dashed line). The dashed horizontal line corresponds to 10% of the kurtosis of a unit Gaussian as calculated based on kurtosis1.

FIG. 7 shows the absolute value of excess kurtosis (kurtosis4, calculated from the quantiles of the distribution) as a function of nᵤₛₑₛ with nₛₕₒₜₛ=52, for (left) the averaged value of 10000 simulations performed for each amplitude value for our proposed algorithm with

$${P}_{fail}^{bound} = 0.95 ,$$

left plot averaged by mean (solid line) and median (small dashed line), and conventional QPE-free QAE, left plot averaged by mean (dot and dash line) and median (large dashed line). The dashed horizontal line corresponds to 10% of the kurtosis of a unit Gaussian as calculated based on kurtosis4.

FIG. 8 shows the absolute value of skewness as a function of nᵤₛₑₛ with nₛₕₒₜₛ=52, for the averaged value of 10000 simulations performed for each amplitude value for our proposed algorithm with

$${P}_{fail}^{bound} = 0.95 ,$$

left plot averaged by mean (solid line) and median (small dashed line), and conventional QPE-free QAE, left plot averaged by mean (dot and dash line) and median (large dashed line). The dashed horizontal line corresponds to no skewness.

FIG. 9 shows the absolute value of bias as a function of nᵤₛₑₛ with nₛₕₒₜₛ=52, for the averaged value of 10000 simulations performed for each amplitude value for our proposed algorithm with

$${P}_{fail}^{bound} = 0.95 ,$$

left plot averaged by mean (solid line) and median (small dashed line), and conventional QPE-free QAE, left plot averaged by mean (dot and dash line) and median (large dashed line). The dashed horizontal line corresponds to no bias.

In particular, it is worth pointing out that the excess kurtosis is generally less than 0.3 for kurtosis1 and 0.291 for kurtosis4 for all amplitude values (and these values corresponding to the horizontal lines in FIGS. 6 and 7 are chosen as good benchmarks for excess kurtosis, as they represent 10% of the kurtosis of a unit Gaussian as calculated based on the given measures, respectively), whilst for approximately nᵤₛₑₛ>3000 the skewness is consistently low, on average around 0.1, and for approximately nᵤₛₑₛ>5000 the bias is very low, on average around 10⁻⁵—effectively unbiased—and appears to be asymptotically decreasing to zero as the uses increase.

As mentioned previously, to our knowledge this is the first time that the statistical properties of the estimator returned by a given QAE algorithm have been analysed in this way, and we are confident that the performance of our particular algorithm, described in detail in this note, is exemplary.

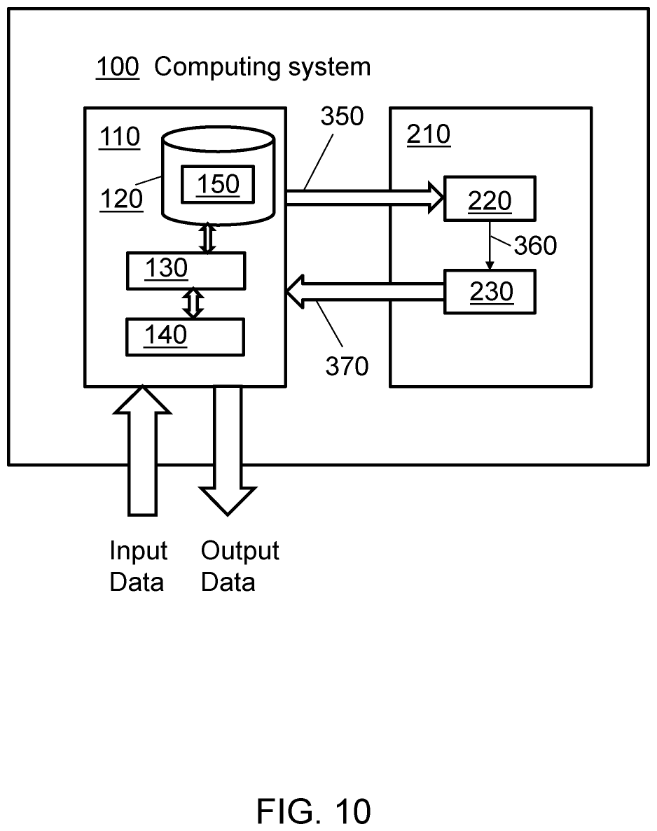

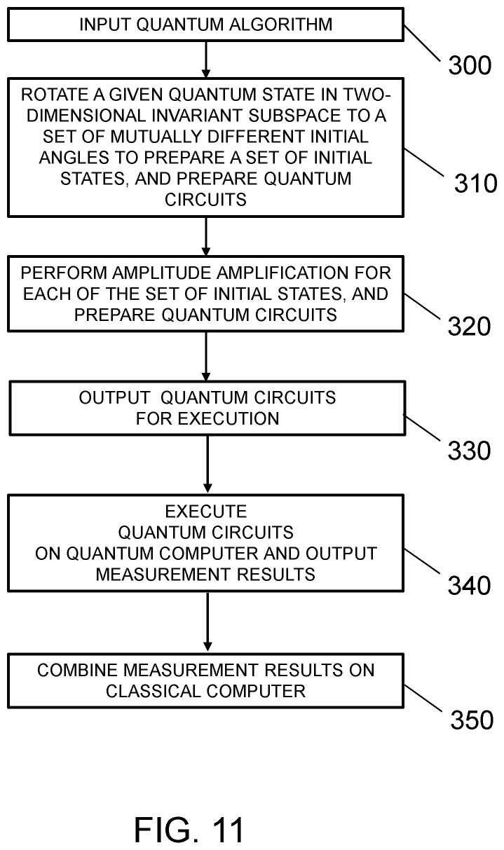

FIG. 10 is a schematic representation of a hybrid computing system 100 including a classical digital computing apparatus 110 and a quantum computing apparatus 210. A sequence of operations to be performed on this system is shown in FIG. 11. Each of the classical computing system 110 and the quantum computing system 210 may comprise one or more computing devices. The classical computer system 110 includes non-volatile data storage 120, at least one volatile memory 130 and at least one processor 140. A Quantum Monte Carlo Integration (QMCI) engine 150 is implemented as a computer program product stored within the non-volatile storage 120 and executable by the processor 140 to carry out a method for generating quantum circuits according to the invention, and for controlling interactions with the quantum computing apparatus. This includes control software for transferring 350 a generated quantum circuit 220 to the quantum computing system for execution. In particular, the QMCI includes a QAE circuit builder implementing a method for transforming a quantum algorithm to generate a plurality of quantum circuits for execution using physical qubits 230 of the quantum computer 210, wherein the quantum algorithm utilizes a quantum-phase-estimation-free quantum amplitude-estimation algorithm for providing an estimate of an amplitude of a given quantum state. The method described above enables generation of a plurality of quantum circuits 150 derived from the same quantum state, which can be implemented 220 on the quantum computer, and then the results of measuring the quantum state on the quantum computer can be processed on the classical computer. This provides efficient computation of statistically robust quantum amplitude estimation, for evaluating states of complex quantum systems.

FIG. 11 shows the steps of a method for quantum amplitude estimation, which involves transforming a quantum algorithm to generate a plurality of quantum circuits for execution using a quantum computer. In particular, the method involves inputting 300 a quantum algorithm to a classical computing apparatus 110 of the hybrid computing system 100 and preparing a plurality of quantum circuits corresponding to a set of initial states, using linear combinations of unitary quantum operations. The set of initial states comprise mutually different initial states, generated by rotating 310 a given quantum state in a two-dimensional invariant subspace to each of a set of mutually different initial angles. One implementation of the method includes performing 320 amplitude amplification for each of the initial states, and this may involve iteratively performing additional amplitude amplifications for each initial state, and generating 330 a quantum circuit for each additional amplitude amplification for each of the initial states. The quantum circuits prepared 330 for each of the initial states are transferred to a quantum computing apparatus 210 within the hybrid quantum-classical computer system and executed 340 to provide quantum state measurements for each of the set of initial states. The preparation of a plurality of different initial states and a plurality of different amplitude amplifications for each of the initial states provides a set of quantum circuits with variations in their quantum measurement results. We then combine 350 measurement results from the plurality of quantum circuit executions for each of the initial states, using post-processing on the classical computing apparatus 110, to return a single value for the amplitude estimation. Combining measurement results from multiple quantum circuit executions corresponding to a plurality of different initial states provides statistically robust data that copes well with computational outliers. The plurality of quantum circuits are implemented on the quantum computing apparatus, mapping 360 the logical qubits of the generated quantum circuit 220 onto physical qubits 230 of the quantum computing apparatus 210 and the quantum circuit is then executed by manipulating these physical qubits to perform calculations including to provide a quantum amplitude estimation result for the quantum state. This is followed by classical post-processing (i.e. additional processing using a classical digital computer) using a combination of measurement results from multiple shots (executions) of the quantum circuit.

### REFERENCES

[1] S. Herbert, “Quantum monte-carlo integration: The full advantage in minimal circuit depth,” 2021. [Online]. Available: https://arxiv.org/abs/2105.09100
[2] A. Montanaro, “Quantum speedup of monte carlo methods,” Proceedings of the Royal Society A: Mathematical, Physical and Engineering Sciences, vol. 471, no. 2181, p. 20150301, 2015. [Online]. Available: https://royalsocietypublishing.org/doi/abs/10.1098/rspa.2015.0301
[3] G. Brassard, P. Hoyer, M. Mosca, and A. Tapp, “Quantum amplitude amplification and estimation,” 2000.
[4] Y. Suzuki, S. Uno, R. Raymond, T. Tanaka, T. Onodera, and N. Yamamoto, “Amplitude estimation without phase estimation,” Quantum Information Processing, vol. 19, no. 2, January 2020. [Online]. Available: http://dx.doi.org/10.1007/s11128-019-2565-2
[5] D. Grinko, J. Gacon, C. Zoufal, and S. Woerner, “Iterative quantum amplitude estimation,” 2019.
[6] S. Aaronson and P. Rall, “Quantum approximate counting, simplified,” Symposium on Simplicity in Algorithms, p. 24-32, January 2020. [Online]. Available: http://dx.doi.org/10.1137/1.9781611976014.5
[7] J. Wachter, “Rare events and financial markets,” 2020. [Online]. Available: https://www.econstor.eu/bitstream/10419/234000/1/2020number1-2.pdf
[8] A. Childs and N. Wiebe, “Hamiltonian simulation using linear combinations of unitary operations,” November 2012. [Online]. Available: https://doi.org/10.26421% 2Fgic12.11-12
[9] L. K. Grover, “A fast quantum mechanical algorithm for database search,” in Proceedings of the Twenty-Eighth Annual ACM Symposium on Theory of Computing, ser. STOC '96. New York, NY, USA: Association for Computing Machinery, 1996, p. 212-219. [Online]. Available: https://doi.org/10.1145/237814.237866
[10] S. Herbert, R. Guichard, and D. Ng, “Noise-aware quantum amplitude estimation,” 2021. [Online]. Available: https://arxiv.org/abs/2109.04840
[11] T.-H. Kim and H. White, “On more robust estimation of skewness and kurtosis,” 2004. [Online]. Available: https://www.sciencedirect.com/science/article/pii/S1544612303000035

1. A method for transforming a quantum algorithm to generate a corresponding target quantum circuit for execution using a quantum computer, wherein the quantum algorithm utilizes a quantum-phase-estimation-free quantum amplitude-estimation algorithm for providing an estimate of an amplitude of a given quantum state, wherein the method includes:
preparing a plurality of quantum circuits for implementing the quantum amplitude estimation algorithm, wherein the preparing of a plurality of quantum circuits involves preparing a set of initial states using linear combinations of unitary quantum operations, wherein the set of initial states comprise mutually different initial states generated by rotating the given quantum state in a two-dimensional invariant subspace to each of a set of mutually different initial angles.

2. The methos of claim 1, further comprising preparing a plurality of quantum circuits for each initial state of the plurality of initial states, wherein the plurality of quantum circuits for each respective initial state of the set of initial states comprises mutually different quantum circuits implementing mutually different numbers of amplitude amplification operations applied to each respective initial state.

3. The method of claim 1 or claim 2, further comprising executing the plurality of quantum circuits on a quantum computing apparatus to output a plurality of quantum measurement results, and combining the output measurement results from execution of the plurality of quantum circuits to provide a quantum amplitude estimation result.

4. The method of claim 3, wherein combining the output quantum amplitude estimation results from execution of the plurality of quantum circuits comprises aggregating the plurality of quantum measurement results on a classical computer.

5. The method of claim 1, wherein each initial angle is based on the weighting of the corresponding linear combination of unitary quantum operations and wherein the method includes specifying the weightings of the linear combinations quasi-randomly.

6. The method of claim 1, wherein each initial angle is based on the weighting of the corresponding linear combination of unitary quantum operations and wherein the method includes specifying the weightings of the linear combinations randomly.

7. The method of claim 1, wherein each initial angle is based on the weighting of the corresponding linear combination of unitary quantum operations and wherein the method includes specifying the weightings of the linear combinations deterministically.

8. The method of claim 1, wherein the phase-estimation-free amplitude-estimation algorithm is configured to provide an estimate for an amplitude of a quantum state, wherein the estimate is generated by performing post-processing on a classical digital computer system for combined measurement data resulting from a plurality of shots of quantum circuits derived from the quantum state.

9. A quantum circuit that is generated by using the method of claim 1.

10. A quantum computing system for transforming a quantum algorithm to implement a corresponding transformed quantum circuit for execution using a quantum computer, wherein the quantum algorithm includes a quantum-phase-estimation-free quantum amplitude-estimation algorithm for providing an estimate of an amplitude of a given quantum state, wherein the quantum system is configured to:
prepare a plurality of quantum circuits for implementing the quantum amplitude estimation algorithm, wherein the preparing of a plurality of quantum circuits involves preparing a set of initial states using linear combinations of unitary quantum operations, wherein the set of initial states comprise mutually different initial states generated by rotating the given quantum state in a two-dimensional invariant subspace to each of a set of mutually different initial angles.

11. The quantum computing system of claim 10, wherein each initial angle is based on the weighting of the corresponding linear combination of unitary quantum operations and wherein the system is configured to specify the weightings of the linear combinations quasi-randomly.

12. The quantum computing system of claim 10, wherein each initial angle is based on the weighting of the corresponding linear combination of unitary quantum operations and wherein the system is configured to specify the weightings of the linear combinations randomly.

13. The quantum computing system of claim 10, wherein each initial angle is based on the weighting of the corresponding linear combination of unitary quantum operations and wherein the system is configured to specify the weightings of the linear combinations deterministically.

14. The quantum computing system of claim 10, wherein the phase-estimation-free amplitude-estimation algorithm is configured to provide an estimate for an amplitude of a given quantum state, wherein the estimate is generated by processing, on a classical computer system, combined measurement data resulting from a plurality of executions of quantum circuits derived from a desired quantum state.

15. The quantum computing system of claim 14, wherein the plurality of executions of quantum circuits comprises execution of a plurality of quantum circuits for each of the set of initial states, wherein the plurality of quantum circuits for each respective initial state of the set of initial states comprises mutually different quantum circuits implementing mutually different numbers of amplitude amplification operations applied to each respective initial state.

16. A software product that is executable on a quantum computer, wherein the software product is arranged to implement the method of claim 1.
